(19) United States
(12) Patent Application Publication
(10) Pub. No.: US 2008/0036822 A1
(43) Pub. Date: Feb. 14, 2008

(54) DROPLET DISCHARGING HEAD AND DROPLET DISCHARGING APPARATUS

(75) Inventor: Kazufumi OYA, Suwa-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/777,633

(22) Filed: Jul. 13, 2007

(30) Foreign Application Priority Data
Aug. 14, 2006 (JP) 2006-221164

(51) Int. Cl. B41J 2/045

(52) U.S. Cl. 347/68

(57) ABSTRACT

A droplet discharging head at least containing a plurality of droplet-discharging nozzle holes to discharge droplets, a plurality of independent droplet discharging chambers that communicate with the respective droplet-discharging nozzle holes and discharge droplets from the droplet-discharging nozzle holes using pressure generated in the chambers, an discharging mechanism for droplet discharging composed of a droplet discharging actuator that is provided at a portion of each of the droplet discharging chambers to generate pressure in the droplet discharging chambers, and a reservoir that communicates commonly with the droplet discharging chambers via an orifice provided at each of the droplet discharging chambers, including: a bubble discharging mechanism for bubble discharge that shares the same reservoir with the droplet discharging mechanism for droplet discharging.

### BACKGROUND

1. Technical Field

The present invention relates to a droplet discharging head having a mechanism for efficiently discharging bubbles stored in the head and to a droplet discharging apparatus equipped with the droplet discharging head.

2. Related Art

As an example of the droplet discharging head, an inkjet head mounted on an inkjet printer is known. For faster, better color printing, the inkjet head is required to have multiple rows of nozzles and a greater number of actuators, meeting challenges to be smaller and have better discharging characteristics. To further improve the discharging characteristics, it is requested that the inkjet head efficiently discharge bubbles that enter or remain in the head.

For example, JP-A-9-314832 (p.4, FIG. 5) discloses an inkjet head with a nozzle used only for discharging bubbles to prevent ink from oozing from an atmosphere aperture at the time of pressure fluctuation in a reservoir, by devising the shape of a bubble-discharging atmospheric communication path provided at a tip of the reservoir.

Also, JP-A-2002-292868 (p.5, FIG. 5) e.g. discloses an inkjet head that prevents bubbles from being stored by partially reducing the decrease in the ink flow speed in a reservoir, by gradually shrinking the area of the reservoir as the distance between the reservoir and an ink supply port increases.

Further, JP-A-2003-63002 (p.7, FIG. 3) e.g. discloses an inkjet recorder, in which ink paths are provided for a slow ink flow at the time of ink discharging and for a rapid ink flow at the time of recovery process, by use of a filter that allows ink to flow only during the slow ink flow so that the recorder discharges the stored bubbles only in the recovery process.

In the technique as described in JP-A-9-314832, the atmospheric communication path for the bubble discharge has no power. Therefore, there must be an external suction power such as a pump to discharge bubbles. In order to reliably lead the bubbles to the atmospheric communication path, the head must be set in a vertical or tilted position so that the side adjacent the communication path faces upward, and, accordingly control of an ink fly path is complicated.

Also, in the technique as described in JP-A-2002-292868, it is not clear whether the difference in the ink flow speed in the reservoir is great enough to influence the bubble discharge characteristics, and the effect of the technique is also not clear. The flow resistance in the path communicated from the reservoir to a pressure supply chamber is markedly greater than the flow resistance in the reservoir, and this flow resistance difference becomes a large obstacle when discharging the stored bubbles from the nozzle. However, no structures are devised involving this matter.

Further, in the technique as described in JP-A-2003-63002, the structure of the head is complex, and the filter needs to be incorporated in each of the heads, resulting in high production costs. Also, a certain volume is required for the reservoir and a bypass used in the recovery process, making it unsuitable for miniaturization of the head.

### SUMMARY

An advantage of the invention is to provide a droplet discharging head having a bubble discharging mechanism used only for bubble discharge to efficiently discharge bubbles stored in the head, and a droplet discharging apparatus equipped with the droplet discharging head.

According to one aspect of the invention, a droplet discharging head at least containing a plurality of droplet-discharging nozzle holes to discharge droplets, a plurality of independent droplet discharging chambers that communicate with the respective droplet-discharging nozzle holes and discharge droplets from the droplet-discharging nozzle holes using pressure generated in the chambers, an discharging mechanism for droplet discharging composed of a droplet discharging actuator that is provided at a portion of each of the droplet discharging chambers to generate pressure in the droplet discharging chambers, and a reservoir that communicates commonly with the droplet discharging chambers via an orifice provided at each of the droplet discharging chambers, including: a bubble discharging mechanism for bubble discharge that shares the same reservoir with the droplet discharging mechanism for droplet discharging.

In this case, the droplet discharging head includes the bubble discharging mechanism for bubble discharge sharing the common reservoir with the separately-provided droplet discharging mechanisms for droplet discharge, and bubbles contained in droplets are discharged by the bubble discharging mechanism optimized for the bubble discharge. Therefore, the bubbles may be efficiently and actively discharged. Also, the bubble discharge may require no external power. Further, because the bubble discharging mechanism for bubble discharge is equipped together with the droplet discharging mechanisms for droplet discharge, it is possible to reduce the number of components and to shrink the size of the droplet discharging apparatus. As a result, the droplet discharging head equipped with the bubble discharging mechanism for bubble discharge may be manufactured at costs similar to the costs for manufacturing a common droplet discharging head.

It is preferable that the bubble discharging mechanism for bubble discharge have: a bubble-discharge nozzle hole that discharges droplets containing bubbles, a bubble discharging chamber that communicates with the bubble-discharging nozzle hole and discharges droplets containing bubbles from the bubble-discharging nozzle hole using pressure generated in the bubble discharging chamber, a bubble discharge actuator provided at a portion of the bubble discharging chamber to generate pressure in the bubble discharging chamber, the bubble discharging mechanism communicating with the reservoir that communicates with the droplet discharging chambers via a supply port provided at the bubble discharging chamber.

In this case, since the bubble discharging mechanism for bubble discharge may be produced simultaneously with the droplet discharging mechanisms for droplet discharge, no extra cost is required.

It is also preferable that the droplet discharging head further include: a partition wall that is equipped with the orifice communicating with the droplet discharging mechanisms for droplet discharging and the reservoir and that divides the droplet discharging chambers of the droplet discharging mechanisms for droplet discharging from the reservoir, and a bubble catch section in the reservoir being in a sectional, substantial L shape surrounded by a surface of the partition wall in the reservoir and a wall surface located on a side adjacent to the actuator.

In this case, because the reservoir includes the bubble catch section having the sectional, substantial L shape surrounded by the partition wall surface and the wall surface located on the side adjacent to the electrostatic actuator, bubbles moving upward against gravitational force may be securely caught in this bubble catch section.

It is further preferable that the bubble discharging chamber of the bubble discharge mechanism be communicated substantially linearly along a wall surface of the bubble discharging chamber via the reservoir and the supply port.

In this case, by eliminating step-like differences present between the reservoir and the bubble discharging chamber of the bubble discharging mechanism, the bubbles caught in the bubble catch section may be readily led to the bubble discharging chamber for bubble discharging.

It is preferable that the wall surface located on the side adjacent to the actuator in the reservoir be made thin so that the thin wall surface provides a diaphragm.

In this case, with the thin wall of the reservoir working as a damper, the diaphragm having such a damper function may buffer pressure fluctuation in the reservoir.

It is also preferable that, in the droplet discharging head, the sectional area of an orifice provided at the bubble discharging mechanism for bubble discharge be larger than the sectional area of the orifice provided at each of the droplet discharging mechanisms for droplet discharging.

In this case, because a flow path resistance from the reservoir to the bubble discharging chamber of the bubble discharging mechanism is smaller than a flow path resistance from the reservoir to the droplet discharging chamber of the droplet discharging mechanism, thereby providing a difference in flow path resistance, the bubbles may be readily led to the bubble discharging chamber for bubble discharging.

It is preferable that a diameter of the bubble-discharge nozzle hole provided at the bubble discharging mechanism for bubble discharge be larger than a diameter of each of the droplet-discharging nozzle holes provided at the droplet discharging mechanisms for droplet discharging.

In this case, because the diameter of the nozzle hole for bubble discharge is made large to be suitable for the bubble discharge, the bubbles contained in the droplets may be efficiently discharged.

It is preferable that an area of the actuator provided at the bubble discharging mechanism for bubble discharge be larger than an area of the actuator provided at each of the droplet discharging mechanisms for droplet discharging.

In this case, because the area of the actuator provided in the bubble discharging mechanism for bubble discharging is made large so as to secure discharging energy necessary for the bubble discharging, the bubbles in the droplets may be reliably discharged.

It is also preferable that the droplet discharging head have one or more bubble discharging mechanisms for bubble discharge.

In this case, because it is not necessary to provide extra bubble discharging mechanism outside the head, it is possible to provide a miniaturized droplet discharging head having a reduced number of components.

It is preferable that the droplet discharging head have a pair of bubble discharging mechanisms for bubble discharge on both sides of the head.

In this case, because the bubble discharging mechanisms can be arranged in a desired distance from the droplet discharging head, it is possible to provide a droplet discharging head in which the discharged bubbles do not interfere with the droplet discharging head.

It is preferable that the bubble discharge actuator have a bubble-discharge oscillator plate made by thinning the wall surface of the bubble discharging chamber and an individual bubble-discharge electrode remote from the bubble-discharge oscillator plate with an air gap interposed therebetween, and apply pressure between the bubble-discharge oscillator plate and the individual electrode to generate pressure therebetween so as to displace the thin bubble-discharge oscillator plate.

In this case, since the structure of the electrostatic actuator for bubble discharge is simple, the bubble discharging mechanism for bubble discharge may be highly dense and manufactured at reduced costs.

Further, it is preferable that the droplet discharging head further include: a nozzle substrate having the droplet-discharging nozzle holes and the bubble-discharge nozzle hole; a reservoir substrate having a first droplet-discharging recess that occupies a portion of each of the droplet discharging chambers, a first reservoir recess that occupies a portion of the reservoir, a first partition wall that communicates with these recesses by using the orifice, a first bubble-discharging recess that occupies a portion of the bubble discharging chamber, and a first reservoir recess that occupies a portion of the reservoir; a cavity substrate having a second droplet-discharging recess that occupies a portion of each of the droplet discharging chambers and has a droplet-discharging oscillator plate, a second reservoir recess that occupies a portion of the reservoir, a second partition wall that partitions these recesses, and a bubble communication recess that has the bubble-discharging oscillator plate, communicates with the recess occupying the portion of the bubble discharging chamber and the recess occupying the portion of the reservoir, and occupies a portion of the bubble discharging chamber and the reservoir; and an electrode substrate having the electrostatic actuator that generates pressure in each of the droplet discharging chambers and the electrostatic actuator that generates pressure in the bubble discharging chamber.

In this case, the droplet discharging head has a four-layered structure stacking the nozzle substrate, the reservoir substrate, the cavity substrate, and the electrode substrate, and provides flow paths and the like in the reservoir. Also, in the droplet discharging head, the bubble discharging mechanism for bubble discharge shares the common reservoir with the droplet discharging mechanisms for droplet discharge, enabling discharging of the bubbles contained in the droplets using the mechanism optimized for bubble discharge. Therefore, it is possible to efficiently and actively discharge bubbles without having to revise the head structure because of this four-layered structure.

According to another aspect of the invention, a droplet discharging apparatus is equipped with the droplet discharging head of the foregoing descriptions.

In this case, it is possible to provide a droplet discharging apparatus that may efficiently and actively discharges droplets containing bubbles.

### BRIEF DESCRIPTION OF THE DRAWINGS

The invention will be described with reference to the accompanying drawings, wherein like numbers reference like elements.

FIG. 1 is an exploded perspective view showing the schematic structure of an inkjet head according to a first embodiment of the invention.

FIG. 2 is an exploded perspective view of FIG. 1 showing the transparent state.

FIG. 3 is an exploded perspective view of FIG. 1 shown from the bottom.

FIG. 4 is an exploded perspective view of FIG. 3 showing the transparent state.

FIG. 5 is a sectional view of a droplet discharging section of FIG. 1 taken on a line I-I′.

FIG. 6 is a sectional view of a bubble discharge section of FIG. 1 taken on a line II-II′.

FIG. 7 is another sectional view of a bubble discharge section, different from that of FIG. 6.

FIG. 8 is an exploded perspective view showing the schematic structure of an inkjet head according to a second embodiment of the invention.

### DESCRIPTION OF EXEMPLARY EMBODIMENTS

Embodiments of the invention will now be described.

A first embodiment of the invention relates to a droplet discharging head equipped with a droplet discharging mechanism for discharging droplets and a bubble discharging mechanism for discharging bubbles. Explained herein as one example of the droplet discharging head is a face discharging type inkjet head which discharges ink droplets from nozzle holes provided on the surface of a nozzle substrate.

### Embodiment 1

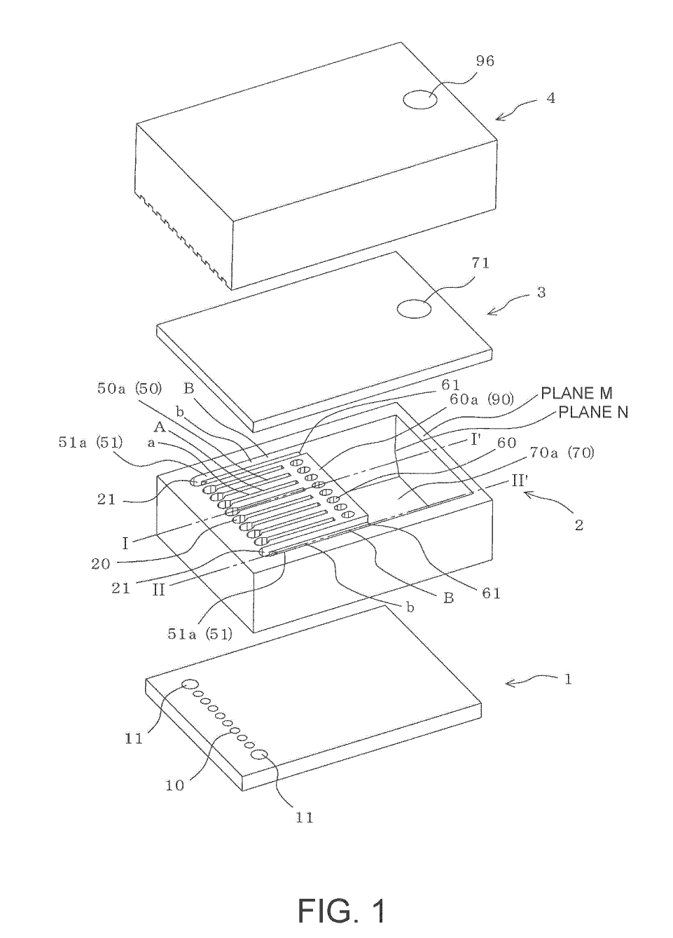

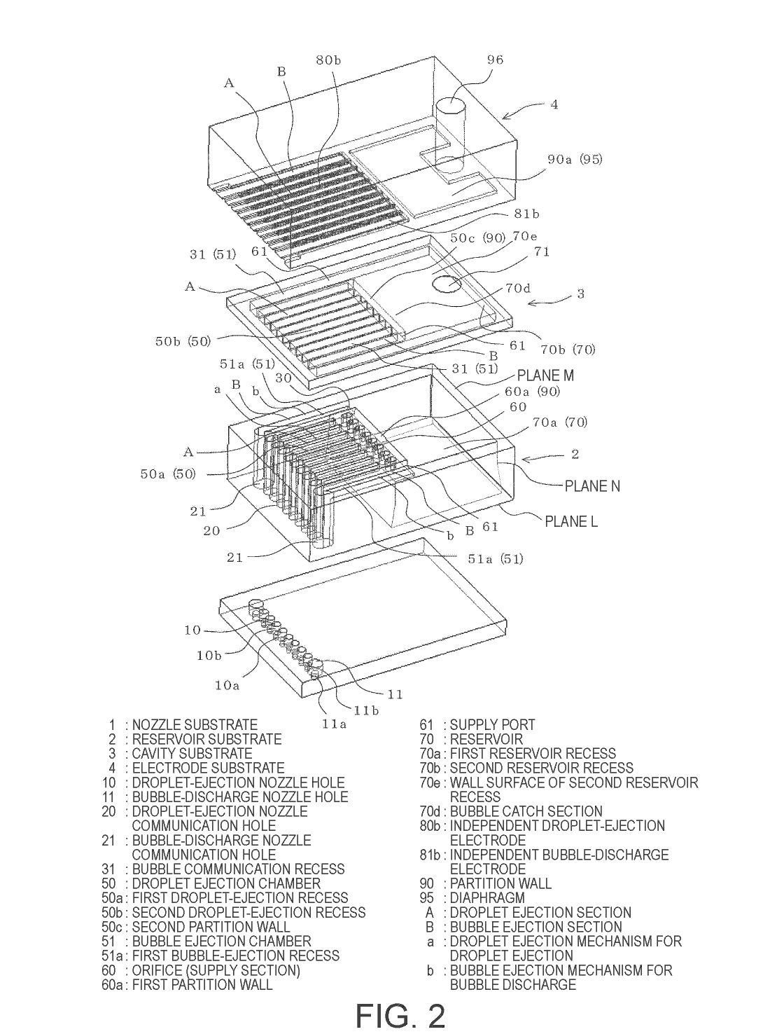

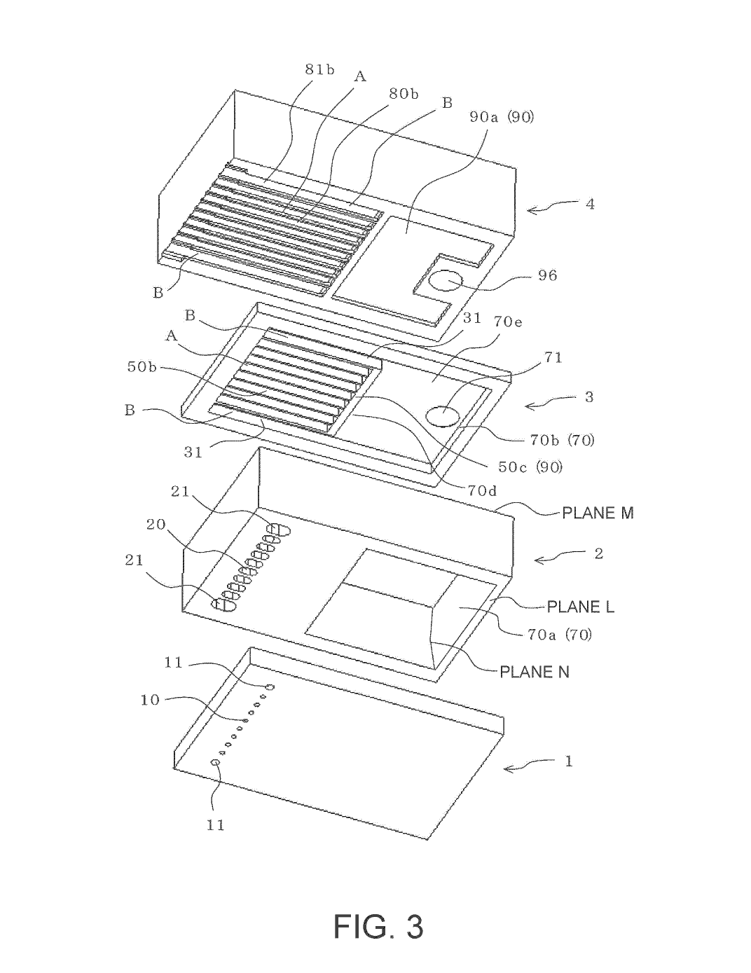

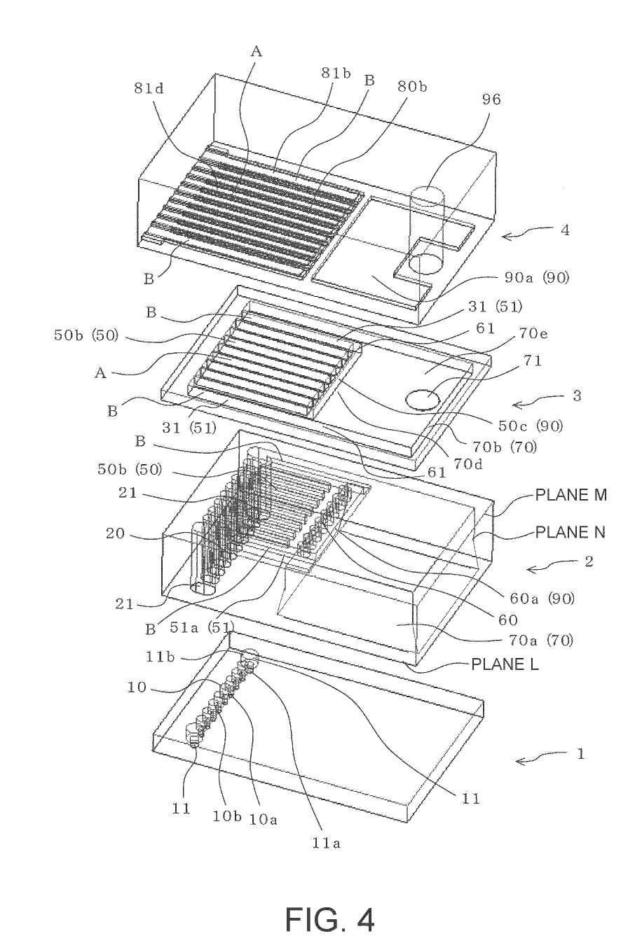

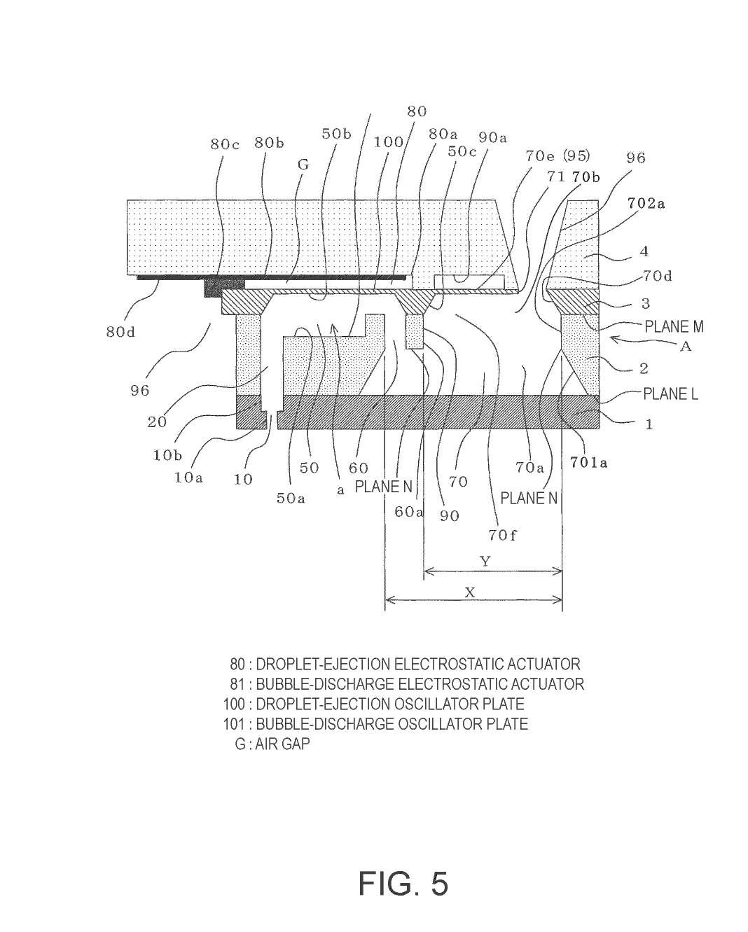

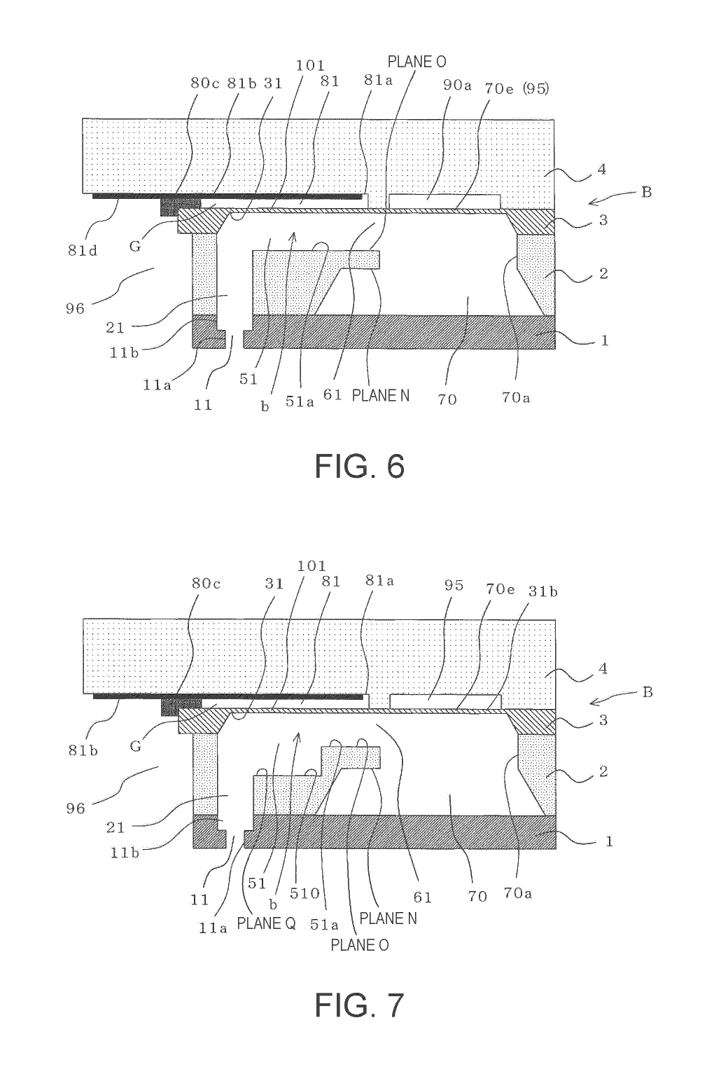

FIG. 1 is an exploded perspective view showing a schematic structure of an inkjet head according to the first embodiment of the invention. FIG. 2 is an exploded perspective view of FIG. 1 showing the transparent state. FIG. 3 is an exploded perspective view of FIG. 1 shown from the bottom. FIG. 4 is an exploded perspective view of FIG. 3 showing the transparent state. FIG. 5 is a sectional view of a droplet discharging section of FIG. 1 taken on a line I-I′. FIG. 6 is a sectional view of a bubble discharge section of FIG. 1 taken on a line II-II′.

With reference to FIGS. 1 through 6, the inkjet head (one example of the droplet discharging head) is a four-layered structure laminating four substrates including, in this order, a nozzle substrate 1, a reservoir substrate 2, a cavity substrate 3, and an electrode substrate 4. The inkjet head is also equipped with a droplet discharging section A containing droplet discharging mechanisms “a” for discharging droplets and bubble discharging sections B each containing a bubble discharging mechanism “b” for discharging bubbles stored in the droplets.

Referring to FIG. 5, each droplet discharging mechanism a in the droplet discharging section A includes: a droplet discharging chamber 50, a droplet-discharging electrostatic actuator 80 provided at a portion of the droplet discharging chamber 50, a droplet-discharging nozzle hole 10 communicated externally from the droplet discharging chamber 50 via a droplet-discharging nozzle communication hole 20, and an orifice (a common section) 60 that communicates with the droplet discharging chamber 50 and a common reservoir (a common ink chamber) 70.

Referring to FIG. 6, the bubble discharging mechanism b in each bubble discharging section B includes: a bubble discharging chamber 51, a bubble-discharge electrostatic actuator 81 provided at a portion of the bubble discharging chamber 51, a bubble-discharge nozzle hole 11 communicated externally from the bubble discharging chamber 51 via a bubble-discharge nozzle communication hole 21, and an orifice (s common section) 61 that communicates with the bubble discharging chamber 51 and the reservoir (the common ink chamber) 70.

The structure of each of the substrates constituting the inkjet head will now be described in detail with reference to FIGS. 1 through 6.

First, the nozzle substrate 1 will be described.

The nozzle substrate 1 is made from a silicon material. The droplet discharging section A of the nozzle substrate 1 has a plurality of droplet-discharging nozzle holes 10 at predetermined intervals. For simplicity FIGS. 1 and 2 show eight droplet-discharging nozzle holes 10 in one row, in addition to the bubble-discharge nozzle holes 11 arranged at the bubble discharging sections B on both sides of the section A. There may be plural rows of droplet-discharging nozzle holes 10. The nozzle holes 10 are arranged perpendicularly and coaxially to the substrate plane, each composed of a droplet jet port 10a of a small hole and a droplet introduction port 10b with a diameter larger than that of the droplet jet port 10a.

The bubble discharging sections B are provided in pair at both sides of the droplet discharging section A. The bubble-discharge nozzle holes 11, each having a diameter larger than that of the droplet-discharging nozzle hole 10, are provided at both ends of and in the same row with the nozzle holes 10 of the droplet discharging section A. Similarly to the droplet-discharging nozzle hole 10, each bubble-discharge nozzle hole 11 is composed of a bubble jet port 11a and a bubble introduction port 11b having a diameter larger than that of the bubble jet port 11a. The ports 11a and 11b have diameters larger than those of the respective ports 10a and 10b of the droplet-discharging nozzle hole 10.

The reservoir substrate 2 will now be described.

The reservoir substrate 2, e.g. in plane direction, is made from a crystal silicon plate whose crystal orientation is (100). In the droplet discharging section A of the reservoir substrate 2, each droplet-discharging nozzle communication hole 20 communicates independently with each droplet-discharging nozzle hole 10 of the nozzle substrate 1 and is disposed coaxially with the nozzle hole 10 of the nozzle substrate 1. The nozzle communication hole 20 has a slightly large diameter (equivalent to or larger than the diameter of the droplet introduction port 10b). Such a structure allows straight discharging of the ink droplets.

A first reservoir recess 70a occupying a portion of the common reservoir 70 communicates via the droplet discharging chamber 50 and the orifice 60 to the droplet-discharging nozzle communication hole 20. The first reservoir recess 70a is composed of a sectional, substantially inverted-funnel-shaped recess in a direction from the bonded plane with the nozzle substrate 1 (hereunder referred to as a plane L) to the bonded plane with the cavity substrate 3 (hereunder referred to as a plane M). More specifically the first reservoir recess 70a is composed of a sectional trapezoid recess 701a that shrinks in size from the plane L to the plane M and of a sectional rectangular recess 702a from a small-size end at a small-size part of the sectional trapezoid recess 701a (a plane containing this end is hereafter referred to as a plane N) to the plane M. Additionally because the sectional rectangular recess 702a includes a first partition wall 60a that allows the orifice 60 to pass through to the droplet-discharging nozzle communication hole 20, the recess 702a has a length Y shorter than a length X at the plane N.

Provided in the reservoir substrate 2 is a thin groove-shaped first droplet-discharging recess 50a that occupies a portion of the droplet discharging chamber 50. The first droplet-discharging recess 50a is provided to prevent increase in the flow path resistance in the droplet discharging chamber 50 caused as a result of thinning the cavity substrate 3, as described hereafter. However, the first droplet-discharging recess 50a may not be provided.

In contrast, provided in the bubble discharging sections B positioned at both sides of the reservoir substrate 2 are the bubble-discharging nozzle communication holes 21 located in the same row as the droplet-discharging nozzle communication holes 20. The bubble-discharge nozzle communication holes 21 penetrate the reservoir substrate 2 perpendicularly thereto, communicate independently with each of the bubble-discharging nozzle holes 11, and are disposed coaxially with the bubble-discharge nozzle holes 11 of the nozzle substrate 1. Each hole 21 has a slightly large diameter (equivalent to or larger than the diameter of the bubble introduction port 11b), and the diameter of the hole 21 is made larger than the diameter of the droplet-discharging nozzle communication hole 20 of the droplet discharging section A.

Also provided is a first reservoir recess 70a that occupies a portion of the reservoir 70 and communicates to the bubble-discharging nozzle communication hole 21 via the bubble discharging chamber 51 and the orifice 61. This first reservoir recess 70a makes a substantially inverted-funnel-like shape in the droplet discharging section A . Note that, in the bubble discharging section B, there is no passing-through section equivalent to the orifice 60 of the first partition wall 60a provided in the droplet discharging section A.

The reservoir substrate 2 also includes a first bubble-discharging recess 51a occupying a portion of the bubble discharging chamber 51. A bubble discharging plane O of the bubble discharging recess 51a is formed in the same height as the height of a droplet discharging plane P of the first droplet-discharging recess 50a occupying a portion of the droplet discharging chamber 50.

According to the explanations above, the bubble discharging plane O of the first bubble-discharging recesses 51a has the same height as the height of the droplet discharging plane P of the first droplet-discharging recess 50a. However, with reference to FIG. 7, out of the bubble discharging plane O of the first bubble-discharging recess 51a, only a part of this bubble discharging plane on the side adjacent to the bubble-discharge nozzle communication hole 21 is lowered, so as to form a bubble discharging plane Q to form a step-like discharging recess 510. Such a step-like discharging recess 510 may be included in the structure of the bubble discharging mechanism b.

On the entire surface of the reservoir substrate 2, an ink protection film made of, e.g., thermal oxidation film (SiO₂ film) (not shown) is provided to protect silicon from corrosion caused by the ink.

The cavity substrate 3 will now be described.

The cavity substrate 3 is made from a silicon material. The droplet discharging section A of the cavity substrate 3 includes second droplet-discharging recesses 50b each of which occupying a portion of the droplet discharging chamber 50. The droplet discharging chamber 50 is composed of these second droplet-discharging recess 50b and the first droplet-discharging recess 50a provided in the reservoir substrate 2.

A wall surface of the droplet discharging chamber 50 (the second droplet-discharging recesses 50b), that is, a wall surface on the side adjacent to the electrostatic actuator 80, or a wall surface of the electrode substrate 4, constitutes a oscillator plate 100. The oscillator plate 100 can be composed of a boron diffusion layer which is formed by diffusing high-concentration boron on silicon. Because etching stop in wet etching is performed satisfactorily when the boron diffusion layer is used as the oscillator plate 100, the thickness and surface roughness of the oscillator plate 100 can be adjusted with high precision.

The cavity substrate 3 also includes a sectional trapezoid-shaped second reservoir recess 70b that occupies a portion of the reservoir 70, the reservoir 70 being the common droplet chamber. An ink supply port 71 is provided on a wall surface 70e of the second reservoir recess 70b (the wall surface on the side adjacent to the electrostatic actuator 80, i.e., the wall surface on the side adjacent to the electrode substrate 4).

Between the second droplet-discharging recesses 50b and the second reservoir recess 70b, a second partition wall 50c is provided and bonded to the first partition wall 60a of the reservoir substrate 2 to form a partition wall 90.

Thus-formed reservoir 70 includes a bubble catch section 70f in a sectional, substantially inversed-recess-shaped portion composed of the second reservoir recess 70b of the cavity substrate 3 and the sectional rectangular recess 70c of the reservoir substrate 2, that is, a portion located closer to the side adjacent to the partition wall 90 than to the ink supply port 71 or a portion surrounded by the sectional, substantial L shape. The wall surface 70e of the second reservoir recess 70b of the reservoir 70 is made thinly so that a diaphragm (described later) for buffering pressure fluctuation occurred in the common reservoir 70 is produced at the time of bonding the cavity substrate 3 to the electrode substrate 4.

In contrast, unlike the droplet discharging section A in which the second droplet-discharging recess 50b and the second reservoir recess 70b are partitioned by the second partition wall 50c, the bubble discharging section B of the cavity substrate 3 does not include a partition wall but includes, instead, a sectional trapezoid-shaped bubble communication recess 31 communicating with the recesses. Thus, the reservoir 70 is formed together with the first reservoir recess 70a of the reservoir substrate 2, and the bubble discharging chamber 51 reaching to the bubble-discharge nozzle communication hole 21 via the supply port 61 is formed together with the first bubble-discharging recess 51a of the reservoir substrate 2. Accordingly in the bubble discharging section B, the flow resistance from the reservoir 70 via each orifice 61 to each droplet discharging chamber 51 is smaller than the flow resistance from the reservoir 70 via each orifice 60 to each droplet discharging chamber 50, so that the droplets containing bubbles can readily move from the common reservoir 70 to the bubble discharging chamber 51.

The wall surface of the bubble discharging chamber 51 (the wall surface on the side adjacent to the electrostatic actuator 81) contains a bubble-discharge oscillator plate 101. The bubble-discharge oscillator plate 101 may be composed of a boron diffusion layer which is formed by diffusing high-concentration boron on silicon.

At least a surface of the cavity substrate 3 (i.e., at least a surface on the side adjacent to the electrostatic actuator 81) contains an insulating film (not shown) made of SiO₂ by plasma chemical vapor deposition (CVD) using, e.g., tetraethylorthosilicate tetraethoxysilane (TEOS) as its material. This insulating film is provided for the purpose of preventing the inkjet head from breakdown or short circuit when driving.

The electrode substrate 4 will now be described.

The electrode substrate 4 is made from a glass material. Namely it is suitable to use borosilicate thermo-resistant hard glass having a thermal expansion coefficient close to that of the silicon material of the cavity substrate 3. The use of borosilicate thermo-resistant hard glass can reduce stress generated between the electrode substrate 4 and the cavity substrate 3 when anodic-bonding the two substrates because the two substrates have similar thermal expansion coefficients. Accordingly the electrode substrate 4 and the cavity substrate 3 can be firmly bonded to each other, and problems such as peeling do not occur.

The droplet discharging section A of the electrode substrate 4 includes recesses 80a each of which at a position on the surface remote from each oscillator plate 100 of the cavity substrate 3. The recess 80a is formed in a predetermined depth by etching. The surface of the recess 80a has an individual droplet-discharging electrode 80b made of indium tin oxide (ITO) by sputtering. An air gap G provided between the droplet-discharging oscillator plate 100 and the individual droplet-discharging electrode 80b greatly influences the discharging characteristics of the inkjet head.

An open end of the air gap G is sealed airtight with a sealant 80c composed of, e.g., an epoxy adhesive agent. As a result, foreign objects, moisture, and the like are blocked from entering into the air gap G, and the inkjet head can maintain high reliability.

The material of the individual droplet-discharging electrode 80b is not limited to ITO but may be indium zinc oxide (IZO) or a metal such as gold and copper. However, because ITO is transparent that makes it easy to identify the bonding condition of the oscillator plate, ITO is generally used.

As described, the droplet-discharging electrostatic actuator 80 (the discharging mechanism for droplet discharging) is provided between the droplet-discharging oscillator plate 100 of the cavity substrate 3 and the individual droplet-discharging electrode 80b of the electrode substrate 4, with the air gap G interposed therebetween.

The wall surface 70e of the reservoir 70 of the cavity substrate 3 is thinly made and bonded to a recess 90a of the electrode substrate 4 at this thin part. The thin wall surface 70e constitutes a diaphragm 95 that buffers the pressure fluctuation generated in the reservoir 70.

In contrast, the bubble discharging section B of the electrode substrate 4 includes recesses 81a each at a position on the surface remote from each oscillator plate 101 of the cavity substrate 3. The oscillator plate 101 is made thinly so that it can be easily driven by electrostatic force. The recess 81a is formed in a predetermined depth by etching. The surface of the recess 81a has an individual bubble-discharge electrode 81b made of ITO by sputtering.

As described, the bubble-discharge electrostatic actuator 81 (the discharging mechanism for bubble discharge) is provided between the bubble-discharge oscillator plate 101 of the cavity substrate 3 and the individual bubble-discharge electrode 81b of the electrode substrate 4, with the air gap G therebetween.

The area of the bubble-discharge electrostatic actuator 81 is made larger than the area of the droplet-discharging electrostatic actuator 80.

Basically during the droplet discharging, the bubble-discharge electrostatic actuator 81 having the above structure is not performing the bubble discharging, that is, it is not driving. However, the bubble-discharge electrostatic actuator 81 may be driven inversely to the droplet-discharging electrostatic actuator 80 at the time of droplet discharging. In this situation, by driving the bubble-discharge electrostatic actuator 81 inversely to the droplet-discharging electrostatic actuator 80 to an extent that ink is not discharged, the pressure fluctuation in the reservoir 70 can be buffered.

Terminals 80d, 81d of the individual electrodes of the electrode substrate 4 (the individual electrodes 80b, 81b of the respective droplet discharging section A and bubble discharging section B) are exposed to an electrode extraction section 96 that is open at the end portions of the reservoir substrate 2 and the cavity substrate 3. At the electrode extraction section 96, a flexible wiring substrate with a drive control circuit is coupled to each of the terminals 80d, 81d of the respective individual electrodes 80b, 81b of the respective droplet discharging section A and bubble discharging section B and to each electrode (not a same electrode for each section A and section B) provided at an end portion of the cavity substrate 3, so as to control the operations (droplet discharging operation and bubble discharging operation) of the inkjet head (not shown).

The operations of the inkjet head having the above structure will now be explained.

Ink in an external ink cartridge (not shown) is supplied to the reservoir 70 of the inkjet head through the ink supply port 71. In the droplet discharging mechanism a of the droplet discharging section A, the ink is filled to the tip of the droplet discharging nozzle hole 10 via the orifice 60, droplet discharging chamber 50, and droplet-discharging nozzle communication hole 20. In the bubble discharging mechanism b of the bubble discharge section B, the ink is filled to the tip of the bubble discharge nozzle hole 11 via each supply port 61, bubble discharging chamber 51, and bubble-discharge nozzle communication hole 21.

First, the ink discharging operations by the droplet discharging mechanism a of the droplet discharging section A will be described.

Upon supply of a drive signal (pulse voltage) to the individual droplet-discharging electrode 80b by the drive control circuit, the pulse voltage is applied from the drive control circuit to the individual electrode 80b thereby positively charging the individual electrode 80b, while negatively charging the corresponding droplet-discharging oscillator plate 100. In this instance, electrostatic force is generated between the individual electrode 80b and the oscillator plate 100, and the generated electrostatic force draws the oscillator plate 100 towards the individual electrode 80b, bending the oscillator plate 100. As a result, the volume of the droplet discharging chamber 50 increases. Then, when the pulse voltage is turned off, this electrostatic force disappears, and the oscillator plate 100 bends back by its own elastic force, while the volume of the droplet discharging chamber 50 decreases rapidly. The pressure created at this time pushes part of the ink in the droplet discharging chamber 50 out of the droplet-discharging nozzle hole 10 as droplets via the droplet-discharging nozzle communication hole 20. Then, as the pulse voltage is applied again, the oscillator plate 100 bends to the individual electrode 80b, and the ink is supplied from the common reservoir 70 via the orifice 60 into the droplet discharging chamber 50.

At the time of discharging ink, the oscillator plate 100 in the droplet discharging mechanism a of the bubble discharging section B is driven to perform the ink discharging. Basically at this time, the bubble-discharge oscillator plate 101 in the bubble discharging mechanism b is not driving but stopped. However, at the time of droplet discharging, also, the oscillator plate 101 in the bubble discharging mechanism b may be inversely driven so as to buffer the pressure fluctuation generated when driving the droplet discharging mechanism a.

Next, the bubble discharge operations by the bubble discharging mechanism b of the bubble discharging section B will be described.

The bubbles contained in the ink in the reservoir 70 are caught in a portion surrounded by a sectional, substantially-L-shaped wall part of the bubble catch section 70f provided in the droplet discharging section A.

To discharge these bubbles contained in the ink, a pulse voltage from the drive control circuit to the droplet discharging mechanism a is turned off first so as to stop the drive of the droplet-discharging oscillator plate 100 of the droplet discharging mechanism a. Then, the inkjet head is moved so that a cap (not shown) for bubble discharge attaches to the bubble-discharge nozzle hole 11 of the inkjet head.

Thereafter, the pulse voltage to the bubble discharging mechanism b is turned on to drive the bubble-discharge oscillator plate 101 of the bubble discharging mechanism b. In this case, because the area of the bubble-discharge electrostatic actuator 81 of the bubble discharging mechanism b is set larger than the area of the droplet-discharging electrostatic actuator 80 of the droplet discharging mechanism a, the discharging energy required to discharge bubbles is secured at the bubble discharging mechanism b.

When the bubble-discharge oscillator plate 101 starts driving, the bubbled caught in a bubble catch section 70d of the reservoir 70 moves along with the ink to the bubble discharging chamber 51 via the supply port 61 of the bubble discharging mechanism b. At this time, because the bubbles contained in the ink move through a wide path of the bubble discharging chamber 51 along the upper plane of the bubble discharging chamber 51, the flow path resistance can be small, and the bubbles in the ink can be easily led to the bubble discharging chamber 51.

The bubbles that have reached to the bubble discharging chamber 51 are discharged along with the ink from the bubble-discharge nozzle hole 11 via the bubble-discharge nozzle communication hole 21. At this time, the bubbles contained in the ink are discharged via the bubble discharge cap attached to the bubble-discharge nozzle hole 11 and absorbed to a sponge or the like via a tube connected to the cap. In this discharging, because the diameter of the bubble-discharge nozzle hole 11 is set larger than the diameter of the droplet-discharging nozzle hole 10 so as to be suitable for discharging bubbles, the bubbles can be efficiently and reliably discharged.

In the descriptions above, the bubble discharging sections B (the bubble discharging mechanisms b) are provided in pair at both sides of the droplet discharging section A (the droplet discharging mechanism a). However, the bubble discharging sections B may be provided at desired positions in the droplet discharging section A, and the number thereof may be one or more than two.

The embodiment 1 is the droplet discharging head including the flow path provided by stacking the nozzle substrate 1, the reservoir substrate 2, the cavity substrate 3, and the electrode substrate 4, in which the bubble discharging mechanism b for bubble discharge is provided separately from the droplet discharging mechanism a for droplet discharging. Because of this discharging mechanism optimized for bubble discharge, the bubble discharge can be conducted efficiently and actively. Also, because no external force is required when discharging bubbles, the number of components can be reduced and the droplet discharging apparatus can be miniaturized.

Also, because the bubble discharging mechanism b of the droplet discharging head includes the bubble discharging chamber 51, the bubble-discharge electrostatic actuator 81 occupying a portion of the bubble discharging chamber 51, the bubble-discharge nozzle hole 11 communicated from the bubble discharging chamber 51 to the exterior, and the supply port 61 communicated from the bubble discharging chamber 51 to the reservoir 70, the bubble discharging mechanism b can be produced simultaneously with the droplet discharging mechanism a, thereby requiring no extra costs.

Moreover, the electrostatic actuator 81 of the bubble discharging mechanism b of the droplet discharging head drives a part of the wall surface of the thinly-made bubble discharging chamber 51 by electrostatic force and thus has a simple structure, the bubble discharging mechanism b can be arranged in a desired number at desired positions.

### Embodiment 2

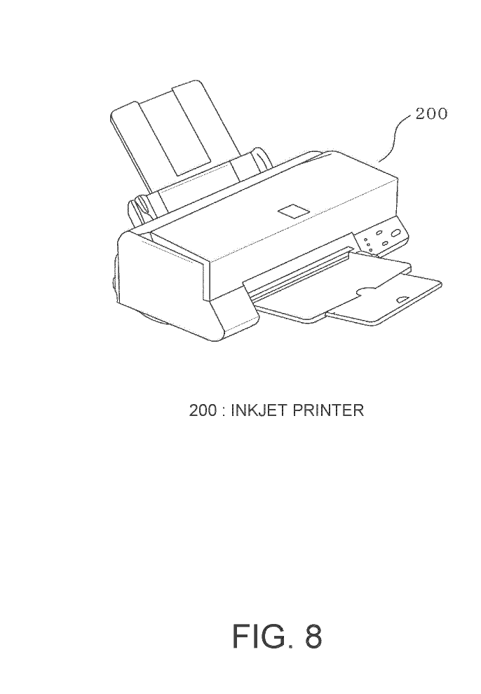

FIG. 8 is a perspective view of the inkjet head applied to an inkjet printer 200, in which the inkjet head is equipped with the droplet discharging mechanisms a of the droplet discharging section A and the bubble discharging mechanism b of the bubble discharging section B. In this case, the ink is discharged to printing paper by the droplet discharging mechanisms a, and the bubbles contained in the ink are discharged and discharged by the bubble discharging mechanisms b. However, liquid to be discharged from the droplet discharging head is not limited to ink. For example, in usage involved with discharging to a substrate as a color filter, it may be a liquid containing pigments for the color filter. In usage involved with discharging to a substrate of a display panel using electroluminescence elements such as an organic compound (e.g., OLED: organic light-emitting diode), it may be a liquid containing compounds that become the electroluminescence elements. In usage involved with wiring on a substrate, it may be a liquid containing, e.g., a conductive metal. Each of these liquids may be discharged from the droplet discharging head provided in each appropriate apparatus. Further, the droplet discharging head may be used as a dispenser for discharging to a substrate that becomes an organic molecular microarray In this case, a liquid containing a probe such as deoxyribonucleic acids (DNA), other nucleic acids, and proteins may be discharged. In addition, the inkjet head is applicable for other usages such as discharging of dyes to cloth or other materials.

What is claimed is:

1. A droplet discharging head comprising:
a plurality of droplet-discharging nozzle holes to discharge droplets;
a plurality of independent droplet discharging chambers that communicate with the respective droplet-discharging nozzle holes and discharge droplets from the droplet-discharging nozzle holes using pressure generated in the chambers;
a discharging mechanism for droplet discharging composed of a droplet discharging actuator that is provided at a portion of each of the droplet discharging chambers to generate pressure in the droplet discharging chambers;
a reservoir that communicates commonly with the droplet discharging chambers via an orifice provided at each of the droplet discharging chambers; and
a bubble discharging mechanism for bubble discharge that shares the same reservoir with the droplet discharging mechanism for droplet discharging.

2. The droplet discharging head according to claim 1, the bubble discharging mechanism for bubble discharge including:
a bubble-discharge nozzle hole that discharges droplets containing bubbles;
a bubble discharging chamber that communicates with the bubble-discharging nozzle hole and discharges droplets containing bubbles from the bubble-discharging nozzle hole using pressure generated in the bubble discharging chamber; and
a bubble discharge actuator provided at a portion of the bubble discharging chamber to generate pressure in the bubble discharging chamber, wherein
the bubble discharging mechanism communicates with the reservoir that communicates with each of the droplet discharging chambers via a supply port provided at the bubble discharging chamber.

3. The droplet discharging head according to claim 1, further comprising:
a partition wall that is equipped with the orifice communicating with the droplet discharging mechanisms for droplet discharging and the reservoir and that divides the droplet discharging chambers of the droplet discharging mechanisms for droplet discharging from the reservoir; and
a bubble catch section in the reservoir being in a sectional, substantial L shape surrounded by a surface of the partition wall in the reservoir and a wall surface located on a side adjacent to the actuator.

4. The droplet discharging head according to claim 3, the bubble discharging chamber of the bubble discharge mechanism being communicated substantially linearly along a wall surface of the bubble discharging chamber via the reservoir and the supply port.

5. The droplet discharging head according to claim 1, wherein the wall surface located on the side adjacent to the actuator in the reservoir is made thin so that the thin wall surface provides a diaphragm.

6. The droplet discharging head according to claim 1, wherein a sectional area of an orifice provided at the bubble discharging mechanism for bubble discharge is larger than a sectional area of the orifice provided at each of the droplet discharging mechanisms for droplet discharging.

7. The droplet discharging head according to claim 1, wherein a diameter of the bubble-discharge nozzle hole provided at the bubble discharging mechanism for bubble discharge is larger than a diameter of each of the droplet-discharging nozzle holes provided at the droplet discharging mechanisms for droplet discharging.

8. The droplet discharging head according to claim 1, wherein an area of the actuator provided at the bubble discharging mechanism for bubble discharge is larger than an area of the actuator provided at each of the droplet discharging mechanisms for droplet discharging.

9. The droplet discharging head according to claim 1, the droplet discharging head having one or more bubble discharging mechanisms for bubble discharge.

10. The droplet discharging head according to claim 9, the droplet discharging head having a pair of bubble discharging mechanisms for bubble discharge on both sides of the head.

11. The droplet discharging head according to claim 1, the bubble discharge actuator having a bubble-discharge oscillator plate made by thinning the wall surface of the bubble discharging chamber and an individual bubble-discharge electrode remote from the bubble-discharge oscillator plate with an air gap interposed therebetween, and applying pressure between the bubble-discharge oscillator plate and the individual electrode to generate pressure therebetween so as to displace the thin bubble-discharge oscillator plate.

12. The droplet discharging head according to claim 1, further comprising:
a nozzle substrate having the droplet-discharging nozzle holes and the bubble-discharge nozzle hole;
a reservoir substrate including:
a first droplet-discharging recess that occupies a portion of each of the droplet discharging chambers;
a first reservoir recess that occupies a portion of the reservoir, a first partition wall that communicates with these recesses by using the orifice; and
a first bubble-discharging recess that occupies a portion of the bubble discharging chamber;
a cavity substrate including:
a second droplet-discharging recess that occupies a portion of each of the droplet discharging chambers and has a droplet-discharging oscillator plate, a second reservoir recess that occupies a portion of the reservoir;
a second partition wall that partitions these recesses,; and
a bubble communication recess that has the bubble-discharging oscillator plate, communicates with the recess occupying the portion of the bubble discharging chamber and the recess occupying the portion of the reservoir, and occupies a portion of the bubble discharging chamber and the reservoir; and
an electrode substrate including:
an first electrostatic actuator that generates pressure in each of the droplet discharging chambers; and
an second electrostatic actuator that generates pressure in the bubble discharging chamber.

13. A droplet discharging apparatus equipped with the droplet discharging head of claim 1.
